(19) United States
(12) Patent Application Publication
(10) Pub. No.: US 2012/0118409 A1
(43) Pub. Date: May 17, 2012

(54) Faucet fountain attachment

(76) Inventor: Michael Stude, Lake Forest, CA (US)

(21) Appl. No.: 13/373,311

(22) Filed: Nov. 10, 2011

Related U.S. Application Data
(63) Continuation-in-part of application No. 12/661,944, filed on Mar. 26, 2010.

(51) Int. Cl. F15D 1/00

(52) U.S. Cl. 137/560

(57) ABSTRACT

The fountain attachment device which is adapted to be mounted to a conventional water faucet. The device has an upper portion for attachment to the faucet, a lower tubular portion for allowing water to flow downward out of a lower outlet opening of the lower tubular portion and an L shaped tubular portion that extends from the lower tubular portion to define at an upper open end thereof, an upper fountain outlet. A cylindrical carbon filter assembly is mounted in the fountain attachment device. A user of the device places a finger over the lower outlet opening to block downward flow of water and water flows out of the upper fountain outlet so that the user, while brushing his teeth can lean down to obtain water from the water flowing out of the fountain outlet to rinse his mouth with filtered water.

### BACKGROUND OF THE INVENTION

1. Field of the Invention

The present invention relates to a fountain attachment device adapted to be attached to a water faucet whereby the downward flow of water from the faucet through the device can be blocked with a hand or finger and an upward extending tubular portion of the attachment can eject water from an upper open end thereof such as like from a fountain. The outwardly flowing water can be easily reached by the mouth of a person brushing his or her teeth for rinsing the mouth with filtered water.

2. Description of the Related Art

Heretofore, individuals brushing their teeth would take water from a glass or cup for rinsing their mouth. The cup or glass becomes coated at the rim with brushing fluid and would need to be washed often.

### BRIEF SUMMARY OF THE INVENTION

According to the teachings of the present invention there is provided a fountain attachment device which is adapted to be mounted to a conventional water faucet in a bathroom. The device has a tubular portion including an upper portion for attachment to the faucet, a lower tubular portion for allowing water to flow downward out of a lower outlet opening of the lower tubular portion and further tubular portion that extends from the side of the lower tubular portion laterally outwardly and then upwardly to define at an upper open end thereof, an upper fountain outlet. A user of the device places a finger or hand over the lower outlet opening to block downward flow of water and water flows out of the upper fountain outlet so that the user, while brushing his or her teeth easily can lean down to obtain water from the water flowing out of the fountain outlet to rinse his or her mouth.

The device is adapted to be releasably attached to a water faucet associated with a bathroom sink and has a lower outlet opening. In use, an individual brushing his or her teeth will put a hand or finger over the lower outlet opening so that water ejects from the upper fountain outlet to permit the individual to lean down and reach the water from the fountain with his or her mouth for rinsing the mouth of toothpaste fluid.

### BRIEF DESCRIPTION OF THE SEVERAL VIEWS OF THE DRAWINGS

FIG. 1 is a perspective view of a water faucet with the fountain attachment device of the present invention attached to the faucet and shows water exiting a fountain outlet of the device and shows the hands of an individual brushing their teeth.

FIG. 2 is a vertical plan view of the fountain attachment device.

FIG. 3 is a top plan view of the fountain device taken along line 3-3 of FIG. 2.

FIG. 4 is a side elevational view of the fountain attachment device taken along line 4-4 of FIG. 2.

FIG. 5 is a perspective view of the fountain attachment device.

### DETAILED DESCRIPTION OF THE INVENTION

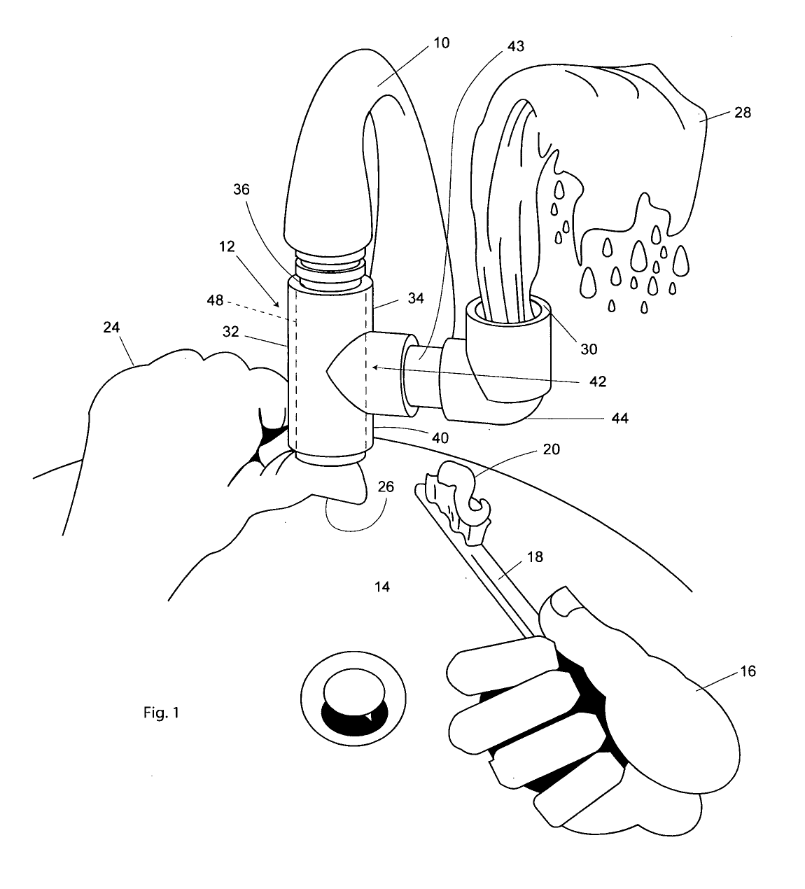

Referring now to FIG. 1, there is illustrated therein a conventional faucet 10, with a fountain attachment device 12, constructed according to the teachings of the present invention attached to the faucet 10 FIG. 1 also shows the faucet 10 positioned over a sink 14, and a person's right hand 16 holding a toothbrush 18, having toothpaste 20, thereon. FIG. 1 also shows a thumb, of a person's left hand 24, positioned over a lower outlet opening 26 of the fountain attachment device 12. Also shown, is a fountain of water 28, exiting upwardly from an upper fountain outlet opening 30, of the fountain attachment device 12.

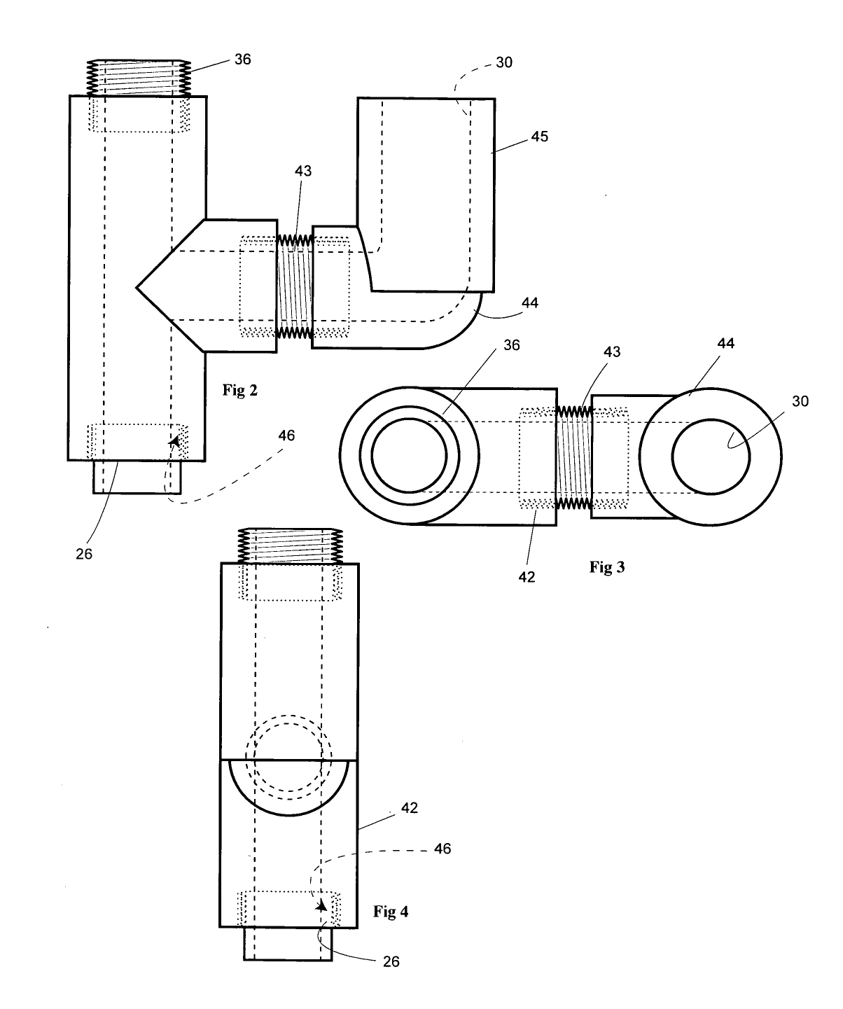

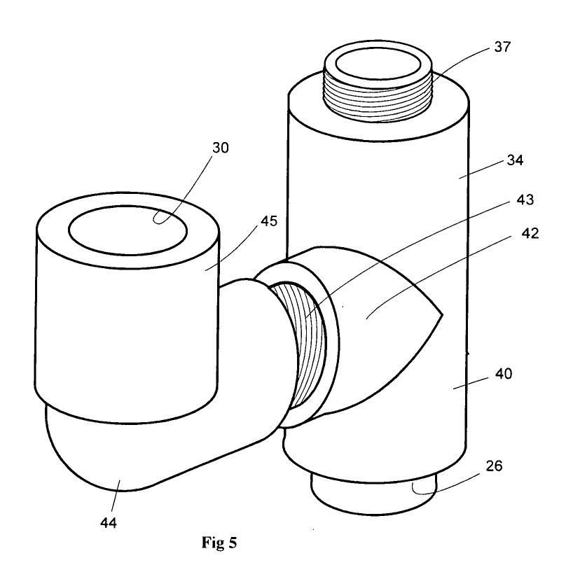

FIG. 2, is an elevational view of the device 12, which includes a generally vertically extending tubular portion 32, having an upper end portion 34, with a tubular threaded boss 36, at the upper end thereof for attachment to a an opening of the faucet 10. The first tubular portion 32 also has a lower tubular portion 40 with a lower tubular outlet opening 26.

A short tubular portion 42 extends laterally outwardly from the generally vertical tubular portion 32 and has a threaded tubular boss 36, at the outer end thereof. Then an L-haped tubular portion 44, is threadably mounted on the threaded tubular boss 36. The upper end of the L shaped tubular member 44 has an upper outlet opening 30, defining the fountain outlet opening 30. The lower tubular portion 40, has on the inside thereof threads 46, to which a conventional faucet water filter assembly 48, can be attached. Preferably the water filter assembly 48 is realized by a Aquasana (Fort Worth, Tex.) model AQ-4025 filter which comprises two 0.5 micron circular carbon filters.

In mounting the device 12 to a faucet, the tubular potion 32 is separately mounted to the faucet 10 by threading the threaded boss into the outlet opening of the faucet 10. Then the L shaped tubular portion 44, is threadably mounted on the threaded tubular boss 36 at the outer end of the tubular portion with the outlet opening 30 of the upper end of the L shaped tubular member 44, defining the fountain outlet opening. Then a water straining device removed from the faucet 10 can be attached to the bottom of the lower tubular portion 40 as shown.

From the foregoing description, it will be understood that obvious modifications can be made to the fountain attachment device 12 of the present invention without departing from the teachings of the invention. For example, the device 12 can be a unitary one piece metal or plastic (PVC) molded device. Accordingly, the scope of the present invention is only to be limited as necessitated by the following claims.

What is claimed is:

1. A fountain attachment device for attachment to a conventional water faucet, said device allowing water to flow downward out of a lower outlet opening and a portion that has an opening defining a fountain outlet and a conventional water filter assembly comprising carbon cylinders is inside said device.

2. The fountain attachment device of claim 1 wherein a conventional filter assembly and said fountain attachment are manufactured together as part of said faucet.

3. The fountain attachment device of claim 1 wherein said portion is an L-shaped tubular portion.

4. The fountain attachment device of claim 1 being a unitary one piece molded device.

5. The fountain attachment device of claim 4 being a unitary one piece device molded from a metal used with faucets.

6. The fountain attachment device of claim 1 being a unitary one piece plastic molded device.

7. The fountain attachment device of claim 1 wherein said portions comprise an elongate tubular portion, and said portion comprises an L-shaped tubular portion coupled to said elongate tubular portion and has an upper opening defining said fountain outlet.

8. The fountain attachment device of claim 7 wherein said elongate tubular portion is threadably coupled to the faucet.

9. The fountain attachment device of claim 7 wherein said L-shaped tubular portion is threadably coupled to said elongate tubular portion.

10. The fountain attachment device of claim 7 wherein said lower outlet opening is located at a lower end of said elongate tubular portion.

11. The fountain attachment device of claim 1 wherein said lower outlet opening is constructed and arranged for being threadably coupled to a conventional filter assembly.
